(19) United States
(12) Patent Application Publication
(10) Pub. No.: US 2009/0193182 A1
(43) Pub. Date: Jul. 30, 2009

(54) INFORMATION STORAGE DEVICE AND CONTROL METHOD THEREOF

(75) Inventor: Tatsuo NITTA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/361,237

(22) Filed: Jan. 28, 2009

(30) Foreign Application Priority Data
Jan. 30, 2008 (JP) 2008-019364

(51) Int. Cl. G06F 12/02; G06F 12/00

(52) U.S. Cl. 711/103; 711/166; 710/52; 711/E12.001; 711/E12.008

(57) ABSTRACT

According to one embodiment, an information storage device includes a non-volatile storage medium, a non-volatile memory configured to store specific data blocks to be read for a host device and write data to be written to the non-volatile storage medium, a buffer configured to temporarily store write data transmitted from the host device, and a controller. The controller is configured to delete synchronized data the same data block as which exists on the non-volatile storage medium among the specific data blocks stored in the non-volatile memory if the free space of the non-volatile memory is smaller than a given data size, and to write the write data stored in the buffer to the non-volatile memory.

### CROSS-REFERENCE TO RELATED APPLICATIONS

This application is based upon and claims the benefit of priority from Japanese Patent Application No. 2008-019364, filed Jan. 30, 2008, the entire contents of which are incorporated herein by reference.

### BACKGROUND

1. Field

One embodiment of the invention relates to an information storage device having a non-volatile memory which functions as a cache and a control method thereof.

2. Description of the Related Art

Generally, in an information processing device such as a computer, an information storage device such as a hard disk drive is utilized. The information storage device stores information in a non-volatile storage medium such as a hard disk.

Recently, an information storage device having a non-volatile storage medium and a non-volatile memory which functions as a cache has been developed. Normally, the non-volatile memory is called a non-volatile cache. The information storage device having the non-volatile cache can perform read/write access of data which is specified by a host at high speed. Further, the information storage device which has the non-volatile cache has an advantage that electric power consumption can be reduced because data can be accessed without rotating a hard disk.

In Jpn. Pat. Appln. KOKAI Publication No. 2005-190187, a storage device which has a hard disk and a non-volatile memory is disclosed. The storage device has a function to perform access to either or both of the hard disk and the non-volatile memory in accordance with an external access request.

However, in the state that most of the storage area of the non-volatile cache is used and free space is insufficient, write data from the host cannot be written to the non-volatile cache. Therefore, the write data needs to be written to the hard disk.

In this case, when the hard disk is not rotating, spin-up of the hard disk is necessary. Therefore, very long time is needed to complete the writing of the write data to the hard disk. Further, even when the hard disk is rotating, it takes long time to complete the writing of the write data due to seek latency.

In this manner, when free space shortage occurs at the non-volatile cache, the write operation of the information storage device becomes slow. If power abnormality such as power failure occurs before the writing of the write data is completed, the write data is lost.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a structure of an information storage device according to an embodiment of the invention;

FIG. 2 is an exemplary block diagram showing a structural example of a controller which is disposed in the information storage device of the embodiment;

FIG. 3 is an exemplary diagram for explaining an operational example of writing write data to a non-volatile memory which is performed by the information storage device of the embodiment;

FIG. 4 is an exemplary diagram for explaining another operational example of writing write data to a non-volatile memory which is performed by the information storage device of the embodiment;

FIG. 5 is an exemplary flowchart for explaining procedure of a data move process which is performed by the information storage device of the embodiment;

FIG. 6 is an exemplary diagram for explaining an example of the data move process which is performed by the information storage device of the embodiment;

FIG. 7 is an exemplary diagram for explaining another example of the data move process which is performed by the information storage device of the embodiment;

FIG. 8 is an exemplary flowchart for explaining procedure of write operation which is performed by the information storage device of the embodiment; and

FIG. 9 is an exemplary block diagram showing another structural example of the information storage device of the embodiment.

### DETAILED DESCRIPTION

Various embodiments according to the invention will be described hereinafter with reference to the accompanying drawings. In general, according to one embodiment of the invention, an information storage device includes a non-volatile storage medium, a non-volatile memory, a buffer, and a controller. The non-volatile storage medium is configured to store specific data blocks to be read for a host device and write data to be written to the non-volatile storage medium. The buffer configured to temporarily store write data transmitted from the host device. The controller is configured to delete synchronized data the same data block as which exists on the non-volatile storage medium among the specific data blocks stored in the non-volatile memory if the free space of the non-volatile memory is smaller than a given data size, and to write the write data stored in the buffer to the non-volatile memory.

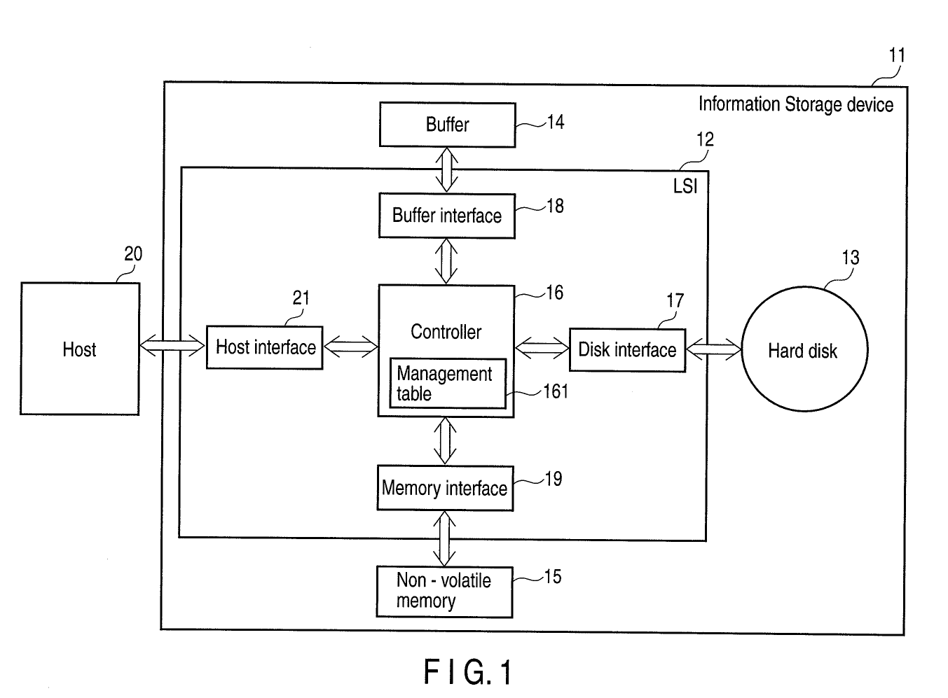

FIG. 1 shows a structure of an information storage device 11 according to an embodiment of the present invention. The information storage device 11 is a device which performs writing of data to a non-volatile storage medium and reading of data from the non-volatile storage medium in accordance with an access request from a host device 20. The information storage device 11 has the non-volatile storage medium and a non-volatile memory which functions as a cache for the non-volatile storage medium. The capacity of the non-volatile memory is smaller than that of the non-volatile storage medium. However, the non-volatile memory can perform data transfer for reading/writing of data at higher speed than the non-volatile storage medium. In the following, it is assumed that the information storage device 11 is realized as a hybrid hard disk drive (HHD). The hybrid HDD is a hard disk drive which has a non-volatile storage medium and a non-volatile memory. In this case, the non-volatile storage medium can be realized by a hard disk which is a rotating medium.

Specifically, the information storage device 11 has an LSI 12 in which various circuit blocks are integrated, a hard disk 13, a buffer 14, a non-volatile memory 15 and the like.

The non-volatile memory 15 is a semiconductor memory which functions as a cache (non-volatile cache) for the hard disk 13 which is a non-volatile storage medium (also called a permanent storage medium). For example, the non-volatile memory 15 can be realized by a flash memory (flash EEPROM) and the like. The non-volatile memory 15 is used for storing specific data (specific data blocks) which is to be read at high speed from the information storage device 11 to the host device 20 and storing write data (write data blocks) which is to be written to the hard disk 13.

With an ordinary HDD, software (kernels in the OS, device drivers in the OS, application programs and the like) and all of user data are stored only on the hard disk 13.

With the information storage device 11 of the present embodiment, a copy of a part of the software or a copy of a part of user data which is stored on the hard disk 13 can be stored in the non-volatile memory 15 as the data to be read at high speed to the host device 20. Accordingly, various data (the software and the user data) can be transferred from the information storage device 11 to the host device 20 at high speed.

The host device 20 can specify which data should be stored in the non-volatile memory 15 among the data stored on the hard disk 13. The information storage device 11 loads the data (also called a data block) corresponding to each of some logical block addresses (LBA) which are specified by the host device 20 from the hard disk 13 to the non-volatile memory 15. The loaded data can be constantly stored in the non-volatile memory 15.

Here, the data to be stored at the non-volatile memory 15 is not limited to the data corresponding to each of the logical block addresses (LBA) which are specified by the host device 20. For example, the information storage device 11 can estimate each logical block address (LBA) which has a high possibility to be requested for reading by the host device 20. Then, the information storage device 11 can load the data corresponding to each of the estimated logical block addresses (LBA) from the hard disk 13 to the non-volatile memory 15 and store the data in the non-volatile memory 15.

Further, in the information storage device 11, it is also possible to store data such as a hibernation file, which is requested for writing by the host device 20, into the non-volatile memory 15.

Furthermore, the non-volatile memory 15 is also utilized as a write cache for temporarily storing write data which is to be written to the hard disk 13. Namely, the write data which is transferred from the host device 20 is temporarily stored in the non-volatile memory 15. Then, for example, when a storage area for the write cache of the non-volatile memory 15 is filled with the write data (data blocks which should be written) or when the information storage device 11 is idle and the hard disk 13 is available for writing, the write data (write data blocks) stored in the non-volatile memory 15 is written to the hard disk 13.

The buffer 14 corresponds to a DRAM cache which is disposed in an ordinary HDD. The buffer 14 can function as a write buffer for temporarily storing write data which is transferred from the host device 20. The buffer 14 is configured of a volatile memory such as a DRAM and an SDRAM. Although the access speed of reading/writing of the buffer 14 is faster than that of the non-volatile memory 15, the capacity of the buffer 14 is smaller than that of the non-volatile memory 15. The write cycle which is performed by the host device 20 is completed when the write data transferred from the host device 20 is stored in the buffer 14.

When a Flush Cache command is received from the host device 20, the information storage device 11 writes the write data (the write data blocks) accumulated in the buffer 14 into the non-volatile memory 15. The Flush Cache command is a Flush command to instruct to write all of the write data stored in the buffer 14 on the hard disk 13.

As mentioned above, by writing the write data stored in the buffer 14 into the non-volatile memory 15 not on the hard disk 13, the write data in the buffer 14 can be stored in a safe storage place which is non-volatile at high speed.

The LSI 12 is an electronic circuit for controlling the operation of the information storage device 11. The LSI 12 includes a controller 16, a disk interface 17, a buffer interface 18, a memory interface 19, a host interface 21 and the like. The controller 16 controls the operation of the information storage device 11 in accordance with various commands from the host device 20. The controller 16 performs communication with the host device 20 via the host interface 21. The communication between the host device 20 and the controller 16 is performed by utilizing various commands which are defined in the ATA8-ACS standard, for example.

The disk interface 17 performs the data transfer between the controller 16 and the hard disk 13. The data writing to the hard disk 13 and the data reading from the hard disk 13 are performed by utilizing a mechanical drive mechanism disposed in the information storage device 11. The drive mechanism has a spindle motor for rotating the hard disk 13, a head, an actuator for moving the head in the radius direction of the hard disk 13 and the like.

The memory interface 19 performs the data transfer between the controller 16 and the non-volatile memory 15. The memory interface 19 is configured of a memory controller for controlling access of the non-volatile memory 15.

The buffer interface 18 performs the data transfer between the controller 16 and the buffer 14. The buffer interface 18 is configured of a DRAM controller, for example.

The controller 16 includes a management table 161. The controller 16 manages the contents of each data block stored in the non-volatile memory 15 by utilizing the management table 161. Specifically, in the management table 161, management information is stored for each data block which is stored in the non-volatile memory 15. The managing information corresponding to each of the data blocks indicates physical address which shows a storage position where the data block is stored in the non-volatile memory 15, the logical block address (LBA) of the data block, the data size of the data block, attribute of the data block and the like. The attribute shows whether or not the data block is a specified data block (the pinned data) corresponding to the LBA which is previously specified by the host device to be maintained in the non-volatile memory 15.

When a read request (read command) is received from the host device 20, the controller 16 reads the data block from either the non-volatile memory 15 or the hard disk 13 in accordance with the address (LBA) contained in the read command.

Specifically, the controller 16 determines whether or not the data block corresponding to the LBA which is specified by the read command exists in the non-volatile memory 15 by referring to the management table 161. When the data block corresponding to the LBA which is specified by the read command is detected to exist in the non-volatile memory 15, the controller 16 reads the data block from the non-volatile memory 15. On the other hand, when the data block corresponding to the LBA which is specified by the read command is detected not to exist in the non-volatile memory 15, the controller 16 reads the data block from the hard disk 13.

In addition, in order to prevent occurrence of delay of write operation caused by free area shortage of the non-volatile memory 15 which is the non-volatile cache, the controller 16 has a function to increase the free area of the non-volatile memory 15 by temporarily deleting a part of the specified data blocks which are stored in the non-volatile memory 15.

Specifically, in the state that most of the storage area of the non-volatile memory 15 is used and free space of the non-volatile memory 15 is insufficient, the write data accumulated in the buffer 14 (one data block or more which is accumulated in the buffer 14 as the write data) cannot be written into the non-volatile memory 15. In this case, normally, the write data needs to be written to the hard disk 13. Then, the delay of write operation occurs. If power abnormality such as power failure occurs before completing the write operation on the hard disk 13, the write data is lost.

Therefore, it is important to enable the write data accumulated in the buffer 14 to be stored in the non-volatile memory 15 even when free space of the non-volatile memory 15 is insufficient. In order to realize the abovementioned, the controller 16 performs the following processes when the abovementioned flush cache command is received, for example.

First, the controller 16 determines whether or not the free space of the non-volatile memory 15 is smaller than a predetermined data size. In the case where the free space is smaller than the predetermined data size, the controller 16 increases the free space of the non-volatile memory 15 by temporarily deleting the data block (synchronized data) the same data block as which exists on the hard disk 13 among the specified data blocks (pinned data, etc.) which are stored in the non-volatile memory 15. Then, the controller 16 writes the write data which is stored in the buffer 14 to the non-volatile memory 15. In this manner, even in the case where the free space of the non-volatile memory 15 is insufficient, the write data accumulated in the buffer 14 can be stored in the non-volatile memory 15 at high speed and the security of the write data can be improved.

The synchronized data (also called media synchronized data) is data block the same data block as which also exists on the hard disk 13. If a certain data block A exists on each of the non-volatile memory 15 and the hard disk 13, the data block A is the synchronized data. Therefore, even if the synchronized data is deleted from the non-volatile memory 15, the synchronized data can be restored in the non-volatile memory 15 by reading it from the hard disk 13.

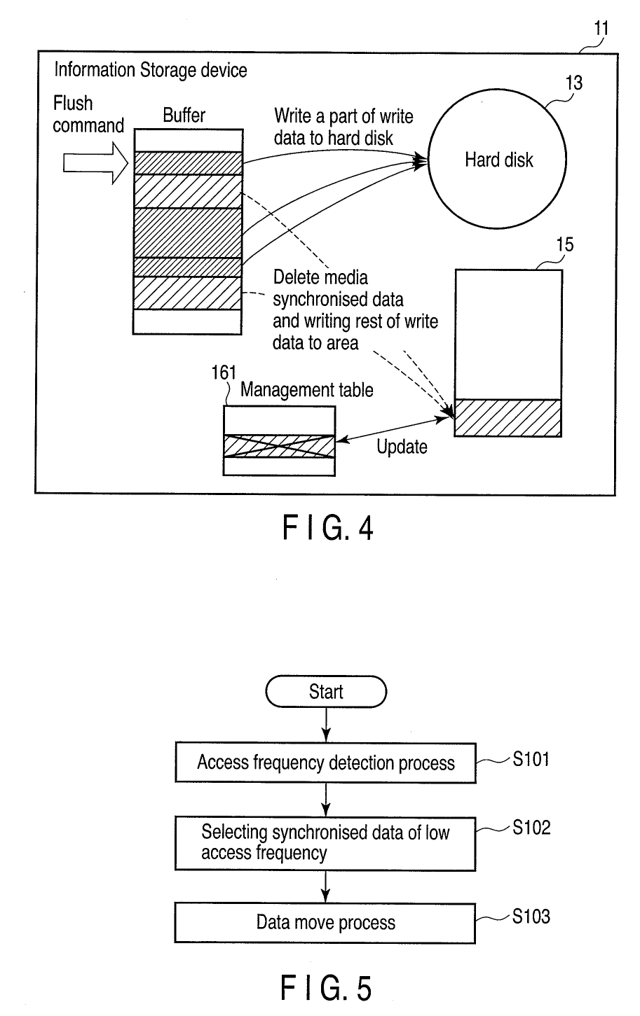

In the present embodiment, the abovementioned delete process of synchronized data is executed in accordance with occurrence of an event which needs storing of write data stored in the buffer 14 into the non-volatile memory 15 at high speed. As factors which cause the events, there exist other factors than the reception of the abovementioned flush cache command. For example, when the write data is written to the buffer 14 in a state that the head is immediately unloaded to a ramp, the abovementioned delete process of synchronized data is executed. Further, when a command instructing execution of a high speed flush process, which is described later in FIG. 4, is received from the host device 20, the abovementioned delete process of synchronized data is performed.

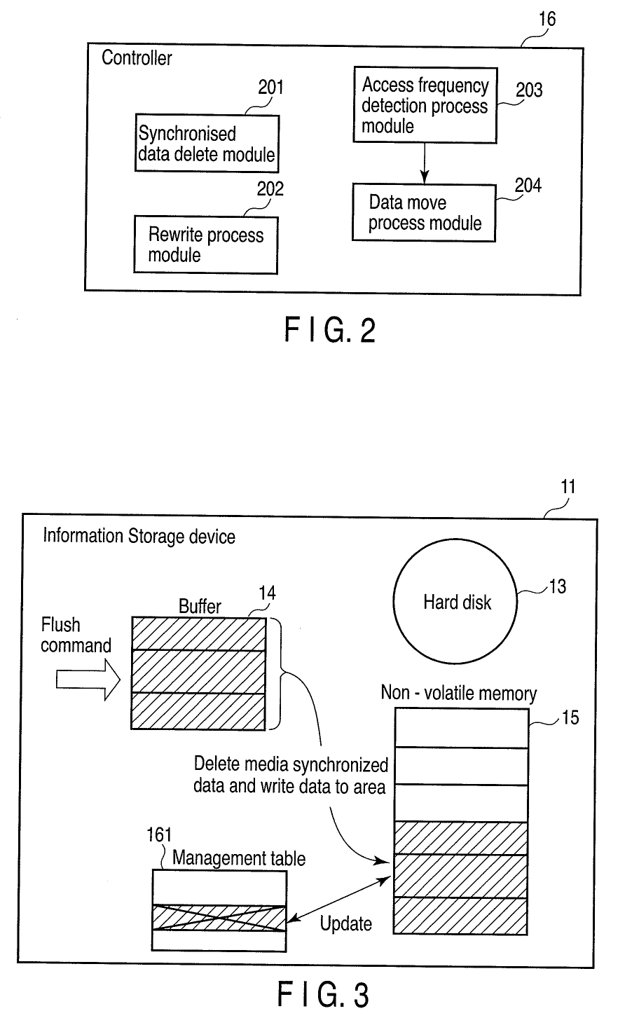

A structural example of the controller 16 is shown in FIG. 2.

In order to execute the abovementioned delete process of synchronized data, the controller 16 includes a synchronized data delete module 201, a rewrite process module 202, an access frequency detection process module 203, and a data move process module 204.

In the case where the free space of the non-volatile memory 15 is smaller than the predetermined data size (for example, the data size of the write data to be written to the non-volatile memory 15), the synchronized data delete module 201 selects synchronized data from among the data blocks which are stored in the non-volatile memory 15 and executes the process to delete the synchronized data. For example, the synchronized date delete module 201 selects, as the synchronized data, each of the data blocks which are loaded from the hard disk 13, from among the specified data blocks corresponding respectively to the LBA specified by the host device 20. In this case, the synchronized data delete module 201 preferentially deletes the data block which is synchronized data and has low access frequency among the data blocks stored in the non-volatile memory 15 based on the access frequency by the host device 20 to each of the data blocks of synchronized data. Namely, the data block having a low access frequency is preferentially deleted among the data blocks of the synchronized data. In this manner, reduction of the read access performance caused by the erase of the data blocks can be suppressed to the minimum.

Here, as mentioned above, it is also possible that the controller 16 itself estimates each logical block address (LBA) which has a high possibility to be requested by the host device 20 and loads the data block corresponding to each of the estimated logical block addresses from the hard disk 13 to the non-volatile memory 15. Therefore, such data block can be selected as the synchronized data (the synchronized data block).

In order to restore the deleted data block in the non-volatile memory 15, the data block which is the same as the data block deleted from the non-volatile memory 15 by the synchronized data delete module 201 is respectively read from the hard disk 13 and written to the non-volatile memory 15 by the rewrite process module 202. For example, the rewrite process is executed after the write data accumulated in the non-volatile memory 15 is written to the hard disk 13.

The access frequency detection process module 203 executes the process to manage access frequency of each data block which is stored in the non-volatile memory 15. Specifically, the access frequency detection process module 203 counts the number of the read access or write access by the host device 20 for each data block stored in the non-volatile memory 15. Here, it is not always necessary to count the actual access number itself accurately. For example, it is also possible to manage the presence or absence of the access during a power cycle of the information storage device 11 (the term from the power ON through the power OFF of the information storage device 11) for each data block. In this case, the value of the access number corresponding to the data block which is accessed one time or more during one power cycle becomes one. The access number corresponding to the data block becomes zero when there is no access at all during one power cycle. Further, it is also possible to manage the access number by taking only the synchronized data stored at the non-volatile memory 15 as the target.

The data move process module 204 executes the data move process for gathering each of the data blocks which have low access frequency among the data blocks into a specific storage area in the non-volatile memory 15 during the normal operation of the information storage device 11 based on the access frequency of each synchronized data (access frequencies of the data blocks which are synchronized data) in the non-volatile memory 15. Namely, the data block which is the synchronized data and has low access frequency among the data blocks stored in the non-volatile memory 15 is gathered into a specific area of the non-volatile memory 15 in advance. In this manner, by gathering each of the data blocks which are to be the erase target, the write data can be effectively written to the free space of the non-volatile memory 15 because continuous storage areas can be assigned as the free space.

In the case where the non-volatile memory 15 is configured of a flash memory which includes a plurality of erase blocks, in the data move process, the synchronized data which have low access frequency among the synchronized data, namely, the data blocks which are the synchronized data and have low access frequency, are respectively gathered into one or more specific erase areas. The process to delete data from the flash memory is executed on the basis of each erase block. Therefore, by gathering the data blocks which are the synchronized data and have low access frequency into one or more specific erase areas in advance, the synchronized data delete module 201 can delete each of the data blocks which are the synchronized data and have low access frequency all together only by executing the block erase process against the specific erase block. Accordingly, the synchronized data delete process (erase process) can be executed at high speed and the necessary free space can be quickly secured.

Further, in the data move process, based on the LBA of each of the synchronized data having a low access frequency, namely, based on the LBA of each of the data blocks which are the synchronized data and have low access frequency, the process of gathering the data blocks whose LBAs are close to one another to the same erase block is executed. Accordingly, the speed of the rewrite process for restoring the data blocks which are the same as the deleted data blocks respectively from the hard disk 13 in the non-volatile memory 15 can be enhanced.

FIG. 3 shows the write operation for writing the write data to the non-volatile memory 15 which is performed at the time of receiving the flush cache command.

As mentioned above, in response to the reception of the flush cache command (flush command) from the host device 20, the controller 16 executes the process (the flush process) of writing each data block accumulated as the write data in the buffer 14 to the non-volatile memory 15. The flush process can be executed in a state that the rotation of the hard disk 13 is stopped. Here, the flush process is executed based on the premise that the free space, namely, the space to which data can be written freely, is sufficiently assigned in the non-volatile memory 15.

In the non-volatile memory 15, the specified data blocks (pinned data, etc.) corresponding to LBAs specified by the host device 20 and the write data blocks which are to be written to the hard disk 13 are mixed.

Each write data block which is stored in the non-volatile memory 15 is new data block which has not been written to the hard disk 13. Therefore, the write data block which is stored in the non-volatile memory 15 is non-synchronized data (media non-synchronized data) for which the same data block does not exist on the hard disk 13.

On the other hand, the synchronized data (the media synchronized data) the same data block as which exists on the hard disk 13 is included in the data blocks (pinned data) corresponding to LBAs which are specified by the host device 20. For example, the data block which is loaded from the hard disk 13 to the non-volatile memory 15 is the synchronized data. Further, there is a case where the same data block exists on the hard disk 13 as the data block even though it is transferred from the host device 20.

Therefore, in the present embodiment, when the free space of the non-volatile memory 15 is insufficient, the controller 16 selects the synchronized data from among the data blocks (for example, pinned data, etc.) which are stored in the non-volatile memory 15, and temporarily deletes the selected synchronized data so that the free space of the non-volatile memory 15 is increased. In this case, the controller 16 also executes the process to update the management table 161 in order to erase the management information corresponding to the deleted synchronized data from the management table 161.

Then, the controller 16 writes each of the write data accumulated in the buffer (the write buffer) 14 to the free space of the non-volatile memory 15 which is secured by the delete of the synchronized data. Accordingly, since only the synchronized data is to be the erase target, there arises no problem due to the data erase.

With the abovementioned process, in the present embodiment, even in the case where most of the storage area of the non-volatile memory 15 is used, the area to which the write data is written can be secured in the non-volatile memory 15 and the write data can be stored in the non-volatile memory 15. Therefore, the response performance against the flush cache command can be improved and the possibility that the write data is lost due to electric power abnormality, etc., can be reduced. In addition, since the process to write the write data stored in the buffer 14 to the non-volatile memory 15 can be executed in a state that the rotation of the hard disk 13 is stopped, the increase of electric power consumption due to the rotation of the hard disk 13 can be prevented.

Next, with reference to FIG. 4, the operation of a high speed data flush process will be explained as another example of the write operation of the write data.

The high speed data flush process is the process, not to write the entire write data accumulated in the buffer 14 to the non-volatile memory 15, but to write a part of the write data accumulated in the buffer 14 to the hard disk 13 and to write the rest of the write data accumulated in the buffer 14 to the non-volatile memory 15. The write operation to the hard disk 13 and the write operation to the non-volatile memory 15 are performed simultaneously.

Specifically, when the flush cache command is received from the host device 20 or when a command which explicitly instructs the execution of the high speed data flush process is received from the host device 20, the controller 16 selects the write data blocks (for example, the data blocks in which LBAs are continuous, etc.) which can be written to the hard disk 13 at high speed from among the write data blocks accumulated in the buffer 14, and writes the selected write data blocks to the hard disk 13. In this case, a reordering process to reorder the selected data blocks in the order of LBA is executed as well.

At the same time as writing the write data blocks to the hard disk 13, the controller 16 selects the rest of the write data blocks (i.e., the write data blocks other than the selected write data blocks) from among the write data blocks accumulated in the buffer 14, and writes the rest of the write data blocks to the non-volatile memory 15.

In the case where the free space of the non-volatile memory 15 is smaller than the total data size of the rest of the write data blocks which are to be written to the non-volatile memory 15, the controller 16 selects the synchronized data (media synchronized data) from among the data blocks (for example, pinned data, etc.) which are stored in the non-volatile memory 15, and deletes the selected synchronized data (media synchronized data) temporarily so as to secure the free space. In this manner, even in the state that the free space of the non-volatile memory 15 is insufficient, the high speed data flush process can be executed.

Next, the data move process which is executed at the background during normal operation of the information storage device 11 will be explained with reference to FIG. 5.

In the present embodiment, the following movement process is executed in order to execute the synchronized data erase process efficiently.

First, the controller 16 counts the number of the read access of the host device 20 for each data block which is stored in the non-volatile memory 15 (Step S101). Then, when a garbage collection process or a wear leveling process is executed in the information storage device 11 or when the information storage device 11 is idle, the controller 16 executes the data move process for relocating each of the data blocks which are stored in the non-volatile memory 15 based on the access number corresponding to each of the data blocks stored in the non-volatile memory 15 (Steps S102, S103).

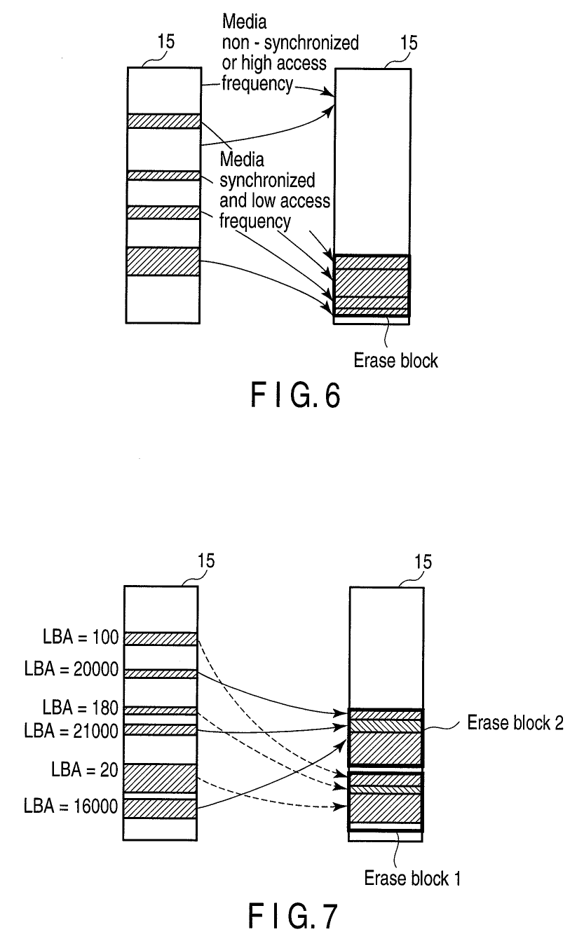

In Step S102, the controller 16 selects the data blocks which are the synchronized data and have low access frequency from among the data blocks which are stored in the non-volatile memory 15. Then, in Step S103, the controller 16 relocates data blocks stored in the non-volatile memory 15 so that the data blocks which are the media synchronized data and has low access frequency are respectively gathered to the specific erase block, as shown in FIG. 6.

Further, in the data move process in Step S103, the controller 16 performs the relocating so that data blocks in which LBAs are close to one another are gathered to the same erase block also in consideration of the LBA for each data block which is the media synchronized data and has low access frequency. The state of relocating is shown in FIG. 7. In FIG. 7, the data block in which LBA is 100, the data block in which LBA is 20000, the data block in which LBA is 180, the data block in which LBA is 21000, the data block in which LBA is 20 and the data block in which LBA is 16000 are the data blocks which are the media synchronized data and have low access frequency. The data blocks in which LBAs are close to one another, namely, the data blocks in which LBAs belong within the predetermined LBA range are moved to the same erase block. In FIG. 7, the data block in which LBA is 100, the data block in which LBA is 180 and the data block in which LBA is 20 are gathered into the erase block 1. Further, the data block in which LBA is 20000, the data block in which LBA is 21000 and the data block in which LBA is 16000 are gathered into the erase block 2.

In the synchronized data delete process, the number of the erase blocks which are to be the erase target varies in accordance with the data size of the write data. For example, if only the erase block 1 is erased in the synchronized data delete process, it is necessary in the rewrite process to execute the process to restore the data block in which LBA is 100, the data block in which LBA is 180 and the data block in which LBA is 20 from the hard disk 13 in the non-volatile memory 15. In this case, the data block in which LBA is 100, the data block in which LBA is 180 and the data block in which LBA is 20 exist at the storage positions on the hard disk 13 being close to one another (for example, on the same track or on two adjacent tracks). Therefore, these data blocks can be efficiently read from the hard disk 13 and the enhancement of the rewrite process speed can be achieved.

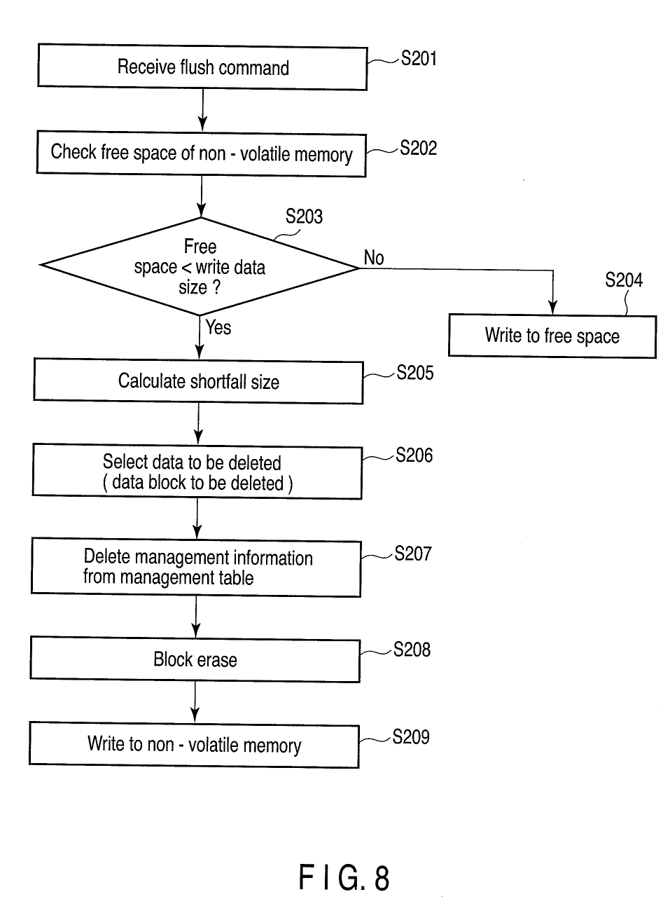

Next, the procedure of the write operation of writing the write data to the non-volatile memory 15 will be explained with reference to the flowchart of FIG. 8.

When a factor which needs high speed storing of the write data of the buffer 14 to the non-volatile memory 15 is generated, for example, when the flush cache command is received from the host device 20 (Step S201), the controller 16 checks the free space of the non-volatile memory 15 (Step S202). Then, the controller 16 compares the free space of the non-volatile memory 15 with the data size of the write data accumulated in the buffer 14 and determines whether or not the free space of the non-volatile memory 15 is smaller than the data size of the write data (Step S203).

When the free space of the non-volatile memory 15 is equal to or larger than the data size of the write data (NO in Step S203), the controller 16 writes the write data accumulated in the buffer 14 to the non-volatile memory 15 (Step S204).

When the free space of the non-volatile memory 15 is smaller than the data size of the write data (YES in Step S203), the controller 16 calculates the shortfall size (the shortfall size=the data size of the write data−the free space of the non-volatile memory 15) (Step S205). Then, the controller 16 determines the data blocks to be deleted from among the data blocks stored in the non-volatile memory 15 based on the shortfall size (Step S206). In Step S206, the data blocks which are synchronized data and have low access frequency are selected as the erase target of the data blocks from among the data blocks (for example, pinned data, etc.) stored in the non-volatile memory 15.

When the data move process is performed such that the data blocks which are synchronized data and have low access frequency are previously gathered into some specific erase blocks, the controller 16 only needs to select the erase blocks which are to be the erase target from among the specific erase blocks based on the shortfall size. Then, the controller 16 erases, from the management table 161, the management information corresponding to each of the data blocks which exist in the selected erase block (Step S207).

Next, the controller 16 deletes the whole data in the selected erase block by executing the block erase process against the selected erase block (Step S208). With this erase process, since the free space of the non-volatile memory 15 is increased, the free space corresponding to the data size of the write data is secured at the non-volatile memory 15. Then, the controller 16 writes each of the write data stored in the buffer 14 to the free space in the non-volatile memory 15 (Step S209). In Step S209, the controller 16 can write the write data to the non-volatile memory 15 in the state that the rotation of the hard disk 13 is stopped.

With the abovementioned process, even in the case where the free space of the non-volatile memory 15 is insufficient, the write data accumulated in the buffer 14 can be stored in the non-volatile memory 15 at high speed.

Here, in Step S203, the free space of the non-volatile memory 15 is determined whether or not it is smaller than the data size of the write data. However, it is also possible to determine whether or not the free space of the non-volatile memory 15 is smaller than a specific data size which is previously determined.

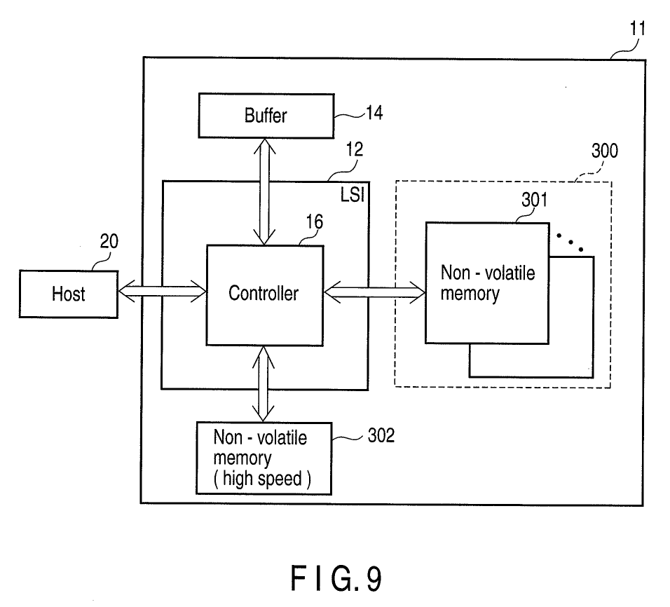

Another structural example of the information storage device 11 of the present invention is shown in FIG. 9.

The information storage device 11 shown in FIG. 9 is realized by an SSD (Solid State Drive) which includes a non-volatile cache. In the information storage device 11 of FIG. 9, a non-volatile storage medium 300 which is configured of a non-volatile memory 301 is disposed instead of the hard disk 13. In addition, a non-volatile memory 302 is disposed as a cache with respect to the non-volatile storage medium 300. The non-volatile memory 302 is a memory device accessible at higher speed than the non-volatile memory 301 in the non-volatile storage medium 300. In the structure of FIG. 9, the read/write access to the non-volatile memory 302 is performed at higher speed than the read/write access to the non-volatile memory 301 in the non-volatile storage medium 300 as well. Therefore, the synchronized data erase process which is described above is also useful for the information storage device 11 of FIG. 9.

As explained above, according to the present embodiment, even in the state that most of the storage area of the non-volatile memory 15 is used, the area to which the write data is written can be secured in the non-volatile memory 15 and the write data can be stored in the non-volatile memory 15 by erasing the synchronized data in the non-volatile memory 15. Further, since the data move process is executed during the normal operation in advance, the process to erase the synchronized data can be executed at high speed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information storage device comprising:
a non-volatile storage medium;
a non-volatile memory configured to store specific data to be read for a host device and data to be written to the non-volatile storage medium;
a buffer configured to temporarily store the data to be written transmitted from the host device; and
a controller configured to delete data synchronized with the data in the non-volatile storage medium among the specific data stored in the non-volatile memory, if a space available in the non-volatile memory is smaller than a threshold data size, and to write the data to be written stored in the buffer to the non-volatile memory.

2. The information storage device of claim 1, wherein the controller is configured to delete data with a substantially low access frequency with priority among a plurality of the synchronized data stored in the non-volatile memory.

3. The information storage device of claim 2, wherein the controller is configured to move data in order to gather data with low access frequencies among the plurality of data into a designated storage area in the non-volatile memory, the data is moved during normal operation of the information storage device.

4. The information storage device of claim 2, wherein the non-volatile memory is a flash memory comprising a plurality of erase blocks, and
the controller is configured to move data during normal operation of the information storage device, to gather data with low access frequencies among the plurality of data into at least one designated erase block in the flash memory, and to erase the whole data in the at least one designated erase block in order to erase the gathered data.

5. The information storage device of claim 4, wherein the data moving comprising gathering data with logical block addresses close to one another among the data with low access frequencies into the same erase block.

6. The information storage device of claim 5, wherein the controller comprises a rewrite module configured to read data being the same as data deleted from the designated erase block from the non-volatile storage medium, and to rewrite the data read from the non-volatile storage medium to the non-volatile memory.

7. The information storage device of claim 1, wherein the non-volatile storage medium comprises a hard disk which is a rotating medium, and
the controller is configured to write the data to be written stored in the buffer to the non-volatile memory in a state that rotation of the hard disk is stopped.

8. The information storage device of claim 1, wherein the non-volatile storage medium comprises a hard disk which is a rotating medium, and
the controller is configured to write a portion to be written among a plurality of data stored in the buffer to the hard disk, and to write the rest of the plurality of data to the non-volatile memory simultaneously.

9. An information storage device comprising:
a non-volatile storage medium;
a non-volatile memory configured to function as a cache, to store specific data to be read for a host device, and to write data to be written to the non-volatile storage medium;
a buffer configured to temporarily store the data to be written transmitted from the host device; and
a controller configured to read a data from either the non-volatile storage medium or the non-volatile memory in accordance with an address comprised in a read request when the read request is received from the host device, and to determine whether a space available in the non-volatile memory is smaller than a threshold data size, when a command instructing to write the data to be written stored in the buffer to the non-volatile storage medium is received from the host device, and configured to delete data synchronized with the data in the non-volatile storage medium among the specific data stored in the non-volatile memory, if the available space is smaller than the threshold data size, and to write the data to be written stored in the buffer to the non-volatile memory.

10. A control method of controlling operation of an information storage device comprising a non-volatile storage medium, a non-volatile memory configured to store specific data to be read for a host device and to write data to be written to the non-volatile storage medium, and a buffer configured to temporarily store the data to be written transmitted from the host device, the method comprising:
reading data from either the non-volatile storage medium or the non-volatile memory in accordance with an address comprised in a read request from the host device;
increasing a space available in the non-volatile memory by deleting data synchronized with the data in the non-volatile storage medium among the specific data stored in the non-volatile memory, if the available space is smaller than a threshold data size; and
writing the data to be written stored in the buffer to the available space of the non-volatile memory.

11. The control method of claim 10, wherein the deleting further comprises deleting data with a substantially low access frequency with priority among a plurality of the synchronized data stored in the non-volatile memory.

12. The control method of claim 11, further comprising moving data during normal operation of the information storage device in order to gather data with low access frequencies among the plurality of data into a designated storage area in the non-volatile memory by the host device.
